(19) United States
(12) Patent Application Publication
(10) Pub. No.: US 2009/0021053 A1
(43) Pub. Date: Jan. 22, 2009

(54) DITCH CLIP ASSEMBLY

(76) Inventors: John H. Harberts, Macomb, MI (US); Daniel B. Fleming, Emmett, MI (US); David W. Raffler, Shelby Township, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/176,062

(22) Filed: Jul. 18, 2008

Related U.S. Application Data
(60) Provisional application No. 60/950,504, filed on Jul. 18, 2007.

(51) Int. Cl. B62D 25/07

(52) U.S. Cl. 296/213

(57) ABSTRACT

A ditch clip assembly may include a main body having at least one cover clip for selectively securing the ditch cover to the main body, and an aperture clip secured to the main body that is configured to secure the main body to an aperture defined by the vehicle ditch. The ditch clip assembly further includes a heat activated sealant or bonding material, e.g., a mastic material, secured to at least one of the main body and the aperture clip. The mastic material may be configured to bond the ditch clip assembly to the ditch upon application of heat at an activation temperature such that the mastic material seals along a perimeter of the aperture.

### CROSS REFERENCE TO RELATED APPLICATIONS

This application claims priority to U.S. Provisional Patent Application 60/950,504, filed Jul. 18, 2007, which is hereby incorporated by reference in its entirety.

### BACKGROUND

Drainage ditches are typically provided along the upper greenhouse area of a motor vehicle to drain water that may accumulate on a vehicle surface, e.g., the vehicle roof. The ditches typically run longitudinally along a vehicle, and form a depression or groove that generally allows water to flow off of the vehicle surface without intruding into a passenger compartment of the vehicle. Ditch covers are often provided for aesthetic reasons. For example, a ditch cover may conceal the drainage ditch, thereby cooperating with the roof or other adjacent vehicle surfaces to define a generally continuous profile.

Ditch covers may be secured to a vehicle using adhesives or other bonding devices that conveniently provide a seal to the interface between adjoining panels near or within the vehicle ditch. Unfortunately, these adhesive or bonding methods generally permanently bond the ditch cover to the vehicle surface, such that the ditch cover and associated installation hardware cannot be removed, e.g., for service, without damaging the vehicle surface to which the ditch cover is bonded.

Accordingly, there is a need for an improved ditch cover that allows for secure installation of the ditch cover while also facilitating easy removal of the ditch cover and associated installation hardware for service or replacement.

### BRIEF DESCRIPTION OF THE DRAWINGS

While the claims are not limited to the illustrated examples, an appreciation of various aspects is best gained through a discussion of various examples thereof. Referring now to the drawings, illustrative examples are shown in detail. Although the drawings represent the various examples, the drawings are not necessarily to scale and certain features may be exaggerated to better illustrate and explain an innovative aspect of an example. Further, the examples described herein are not intended to be exhaustive or otherwise limiting or restricting to the precise form and configuration shown in the drawings and disclosed in the following detailed description. Exemplary illustrations of the present invention are described in detail by referring to the drawings as follows.

FIG. 1 is a top plan view of a vehicle with a pair of roof ditch moldings secured to the vehicle;

FIG. 2 is a partial left side elevational view of the vehicle illustrated in FIG. 1 showing locations in which the roof ditch molding is secured to the vehicle;

FIG. 3A is a lower view of a ditch clip assembly having a selectively removable aperture clip;

FIG. 3B is a raised elevational view of the ditch clip assembly of FIG. 3A;

FIG. 3C is a section view of the ditch clip assembly of FIG. 3A;

FIG. 4 is a section view of a ditch clip assembly having an integral aperture clip secured to a vehicle outer surface;

FIG. 5 is a section view of a ditch clip assembly having an integral fastener and a separately formed mastic material secured to a vehicle outer surface;

FIG. 6 is a section view of a ditch clip assembly having an alignment feature secured to a vehicle outer surface; and

FIG. 7 is an exemplary process flow diagram of a method for assembling a ditch clip assembly.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

Moreover, there are a number of constants introduced in the discussion that follows. In some cases illustrative values of the constants are provided. In other cases, no specific values are given. The values of the constants will depend on characteristics of the associated hardware and the interrelationship of such characteristics with one another as well as environmental conditions and the operational conditions associated with the disclosed system.

According to various exemplary illustrations, a ditch clip assembly and a method of making the same are disclosed. A ditch clip assembly may include a main body having at least one cover clip for selectively securing the ditch cover to the main body, and an aperture clip secured to the main body that is configured to secure the main body to an edge of an aperture defined by the vehicle ditch. The ditch clip assembly further includes a heat activated sealant or bonding material, e.g., a mastic material, secured to the main body and/or the aperture clip. The mastic material may be configured to bond the ditch clip assembly to the ditch upon application of heat at an activation temperature such that the mastic material seals along a perimeter of the aperture.

According to various exemplary illustrations provided herein, a method of making a ditch clip assembly may include forming a main body having at least one cover clip for selectively securing a ditch cover to the main body, providing an aperture clip for securing the main body to an aperture defined by the vehicle ditch; and securing a mastic material to the main body. The mastic material is configured to bond the ditch clip assembly to the ditch upon application of heat at an activation temperature, such that the mastic material seals along a perimeter of the aperture. In some cases it may be desirable to seal substantially the entire perimeter and potentially seal the entire perimeter.

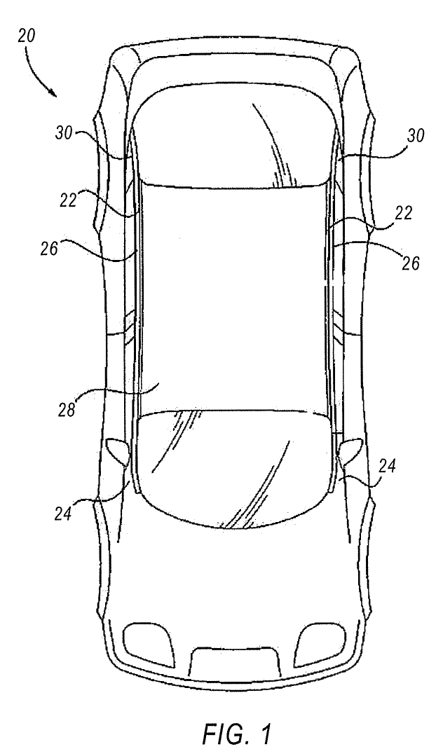

Turning now to FIG. 1, a vehicle 20 is shown with a pair of roof ditch covers 22 that extend in a generally longitudinal direction along the right and left sides of vehicle 20. Left and right roof ditch covers 22 may generally extend continuously from lower portions of left and right front pillars 24, along left and right side portions 26 of a roof exterior surface, to lower portions of left and right rear pillars 30, respectively. More particularly, each of ditch covers 22 include a roof molding section that extends generally longitudinally along the roof exterior surface 28 of the vehicle 20, a front pillar molding section integrally formed with the roof exterior surface 28 to extend generally parallel to the left or right front pillar 24, and a rear pillar molding section integrally formed with the roof exterior surface 28 to extend generally parallel to the left or right rear pillar 30. Each of ditch covers 22 may be configured and arranged such that the roof exterior surface 28, the front pillar molding portion and the rear pillar molding portion of each of the ditch covers 22 have a generally constant transverse cross sectional shape, if desired.

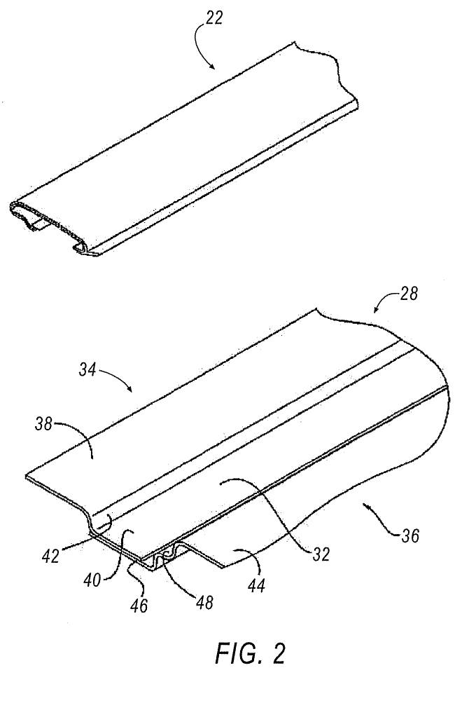

As seen in FIG. 2, the ditch cover 22 may be installed in a generally U-shaped drainage groove 32 that is formed in a longitudinal edge portion of the roof exterior surface 28 as discussed below. The right ditch cover 22 is installed in a generally U-shaped drainage groove 32 that is formed in a right longitudinal edge portion of the roof exterior surface 28 in the same manner as left roof ditch cover 22. Thus, the left roof ditch cover 22 will be illustrated herein.

Ditch cover 22 may be secured to vehicle 20 at a plurality of predetermined locations. More specifically, the roof molding section of ditch cover 22 may be secured to roof exterior surface 28 by a plurality of roof fasteners at a plurality of roof mounting locations (not shown). The front pillar molding section and the rear pillar molding section of the ditch cover 22 are secured to the front pillar 24 and the rear pillar 30, respectively (shown in FIG. 1), by a plurality of pillar fasteners at a plurality of front pillar mounting locations and a plurality of rear pillar mounting locations (not shown). The mounting locations are not limited to those specifically described herein, and the precise number and locations of the mounting locations can be varied based on a particular vehicle configuration, and may even include vehicle locations not associated with a particular pillar.

Ditch cover 22 may be secured to any roof exterior surface 28 defining a groove or ditch. For example, as shown in FIG. 2, roof exterior surface 28 may include a roof panel 34 that extends in a generally horizontal direction to form an outer roof surface of vehicle 20, and a side panel 36 that forms a side portion of vehicle 20. Roof panel 34 may be a rigid press-formed member, e.g., sheetmetal that includes a roof main portion 38, a lateral roof edge portion 40, and a roof vertical portion 42 disposed therebetween. Roof edge portion 40 may be disposed outwardly with respect to the roof main portion 38 and extend in a generally longitudinal direction of the vehicle 20. Roof vertical portion 42 may extend in a generally vertical direction between the roof main portion 38 and the roof edge portion 40 so that the roof edge portion 40 is downwardly offset from the roof main portion 38. Further, roof vertical portion 42 may have any other general shape or configuration defining at least some vertical extension, thereby allowing a downward offset between roof main portion 38 and roof edge portion 40. For example, roof vertical portion 42 may be sloped between roof main portion 38 and roof edge portion 40.

Side panel 36 may be a rigid press-formed member, e.g., sheetmetal, which includes a side outer portion 44, a lateral side edge portion 46 and a side vertical portion 48 as seen in FIG. 2. Lateral side edge portion 46 may be disposed inwardly with respect to side outer portion 44 and extends in a generally longitudinal direction of vehicle 20. Side vertical portion 48 may extend in a generally vertical direction between side outer portion 44 and side edge portion 46 such that side edge portion 46 is downwardly offset from side outer portion 44. As with roof vertical portion 42, side vertical portion 48 may have any general shape or configuration allowing a downward offset between side outer portion 44 and side edge portion 46.

Roof panel 34 and side panel 36 may be secured together at the roof edge portion 40 of the roof panel 34 and the side edge portion 46 of the side panel 36 to form the generally U-shaped drainage groove 32 between the roof panel 34 and the side panel 36. Roof panel 34 and side panel 36 may be secured by any known method, e.g., welding. The drainage groove 32 may extend in a generally longitudinal direction at a lateral edge portion on the roof of the vehicle 20. More specifically, when the roof edge portion 40 and the side edge portion 46 are coupled together, roof vertical portion 42 and side vertical portion 48 conveniently form a pair of side walls of the U-shape drainage groove 32, and roof edge portion 40 and side edge portion 46 together form a bottom portion of the drainage groove 32. Ditch cover 22 may be secured within the drainage groove 32 in a transverse direction such that ditch cover 22 generally covers a coupling portion between roof edge portion 40 of roof panel 34 and side edge portion 46 of the side panel 36.

Ditch cover 22 may be installed to any other roof ditch formed in a roof of vehicle 20. Further, drainage groove 32 need not be formed by separate panels such as roof panel 34 and side panel 36. For example, drainage groove 32 may be stamped into a single sheetmetal panel. Conveniently, use of a separate roof panel 34 and side panel 46 allows for a generally rigid roof structure that is commonly used in vehicle mass manufacturing environments.

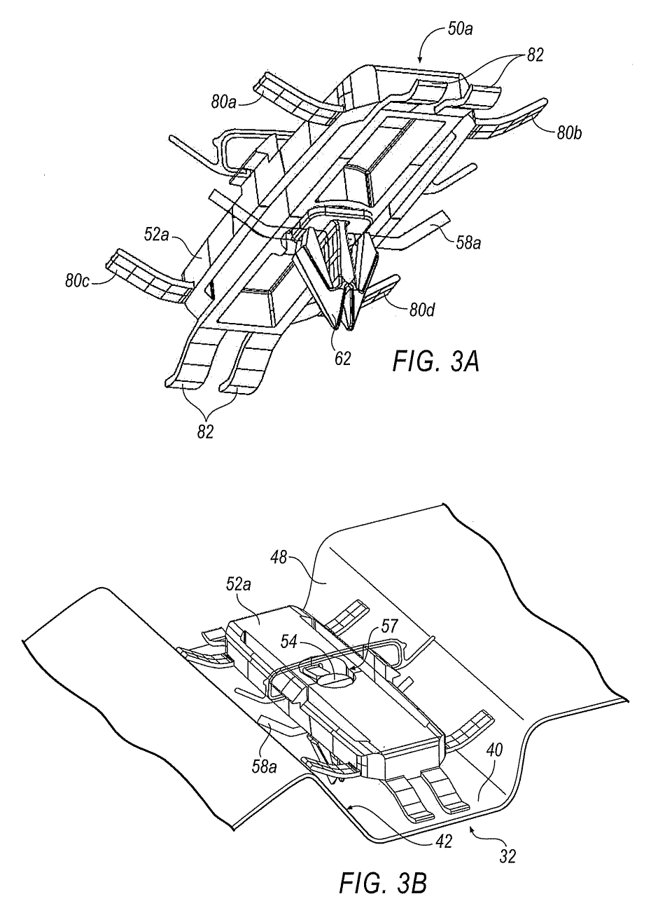

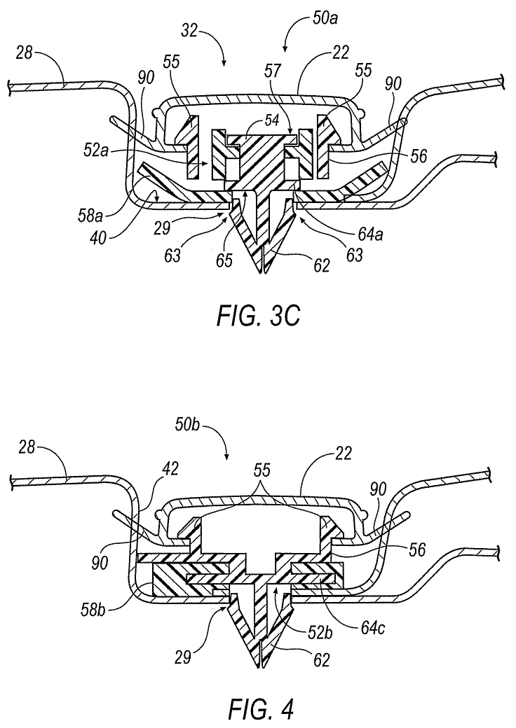

Turning now to FIGS. 3A-3C and 4-6, various exemplary illustrations of a ditch clip assembly 50 are shown. Ditch clip assembly 50 may be installed in a roof ditch 32 of a vehicle 20, and may generally include a main body 52 coupled with a mastic material 58. Main body 52 may be shaped to correspond to the ditch 32, i.e., main body 52 may be elongated such that it extends along the ditch 32. Main body 52 may be formed of any material that is convenient. For example, main body 52 may be formed of any known plastic, nylon, or acetel material, or the like. Main body 52 may be secured to vehicle outer surface 28 with a fastener such as an aperture clip 62, and/or with an adhesive or bonding material such as mastic material 58. Mastic material 58 is an adhesive material that is generally non-tacky and relatively hard at normal temperatures, e.g., room temperature or any temperature range associated with vehicle operation, to allow handling and assembly with main body 52, but becomes soft or flowable upon application of heat at a predetermined activation temperature, thereby bonding main body 52 and/or aperture clip 62 to vehicle outer surface 28. The mastic material 58 may assume a hardened state when cooled back to normal temperatures, e.g., room temperature or other temperature ranges associated with vehicle operation. One example of a known mastic material is Hot Melt Sealer, commercially available from L&L Products of Romeo, Mich. The mastic material 58 may have an activation temperature at a substantially elevated temperature, such as those commonly associated with an automotive paint baking process, e.g., 250 degrees to 350 degrees Fahrenheit. The mastic material may become relatively soft or otherwise generally flowable after exposure to the activation temperature for a certain period of time, e.g., 30 minutes, such that it adheres to the vehicle sheetmetal or coating of the sheetmetal, e.g., galvanized coating or electro-coating. After the material is cooled back to normal ambient temperature, e.g., room temperature or other operating temperature ranges for the vehicle, the mastic material 58 may become generally hardened such that it forms a hardened bond between the sheetmetal and other objects, e.g., main body 52 or aperture clip 62.

Main body 52 may generally be coupled with a ditch cover or cover 22, as further described below. The ditch cover 22 may generally define aesthetic and/or functional features for the ditch clip assembly 50 and the vehicle. For example, as best seen in FIGS. 3C, 4, 5, and 6, the ditch cover 22 may include sealing lips 90 that are disposed on opposing sides of the ditch cover 22, configured to abut opposing sides of a roof ditch, thereby generally inhibiting intrusion of water or other contaminants beneath the ditch molding 22. The ditch cover 22 may also cooperate with the adjacent vehicle surfaces to define a desired overall surface contour, or provide functional features along the ditch, e.g., accessory attachment points, tie-down features, etc.

Turning now to FIGS. 3A-3C, a ditch clip assembly 50a is shown secured to roof ditch 32 of a vehicle exterior surface 28. Ditch clip assembly 50a generally includes a main body 52a that is assembled to the vehicle exterior surface 28 and includes at least one cover clip 55 for securing a ditch cover 22 to main body 52a. Ditch clip assembly 50a further includes an aperture clip 62 which is operable to be secured to an edge of aperture 29 formed in vehicle exterior surface 28 or roof ditch 32. The aperture clip 62 is received by the main body 52, as will be described further below. For example, as shown in FIGS. 3A-3C, aperture clip 62 may be a generally W-shaped clip that is inserted to aperture 29. The generally W-shaped clip may include one or more upwardly extending tangs 63 that engage an edge of aperture 29. Any other type of aperture clip 62 may be employed, e.g., a Christmas tree-type fastener or other push-in fastener for engaging an edge of aperture 29 or any other feature of vehicle outer surface 28. Ditch clip assembly 50a may further include a mastic material 58a disposed about aperture clip 62.

Mastic material 58a may be assembled with or formed around any portion of main body 52a or aperture clip 62 that is convenient. The mastic material 58a may extend along the main body 52a, at least in the vicinity of the aperture clip 62. For example, as best seen in FIG. 3C, mastic material 58a may be formed adjacent a platform 64a that extends away from main body 52a, the platform defining a surface 65 that is spaced away from the main body 52a. Mastic material 58a may be formed separately from main body 52a and aperture clip 62 in any manner that is convenient, and assembled therewith. For example, mastic material 58a may be extruded. Alternatively, as will be described below, mastic material 58a may be insert-molded about platform 64a or otherwise integrally formed with main body 52a and/or aperture clip 62.

Mastic material 58a may be formed of any material that is relatively hard and non-tacky to allow assembly with main body 52a, while becoming soft, tacky, or otherwise flowable under application of heat at a predetermined activation temperature. For example, for vehicle applications it may be convenient for mastic material 58a to become soft, tacky, or otherwise flowable at a temperature at or less than a paint baking temperature associated with the vehicle assembly process. Mastic material 58a thus may permanently bond or secure the main body 52 and/or aperture clip 62 to the vehicle. Accordingly, main body 52a and mastic material 58a may be initially assembled together or formed together, as described above, and assembled to vehicle outer surface 28 within ditch 32. For example, main body 52a may be secured to vehicle outer surface 28 with aperture clip 62. Mastic material 58a may be subsequently heated, for example during a vehicle assembly process, such that mastic material 58a becomes generally tacky, soft, or flowable, thereby generally bonding aperture clip 62 and/or main body 52a to vehicle outer surface 28. In the example shown in FIGS. 3A-3C, mastic material 58a may generally permanently bond at least the surface 65 of platform 64 to the roof edge portion 40 of ditch 32, such that aperture clip 62 may not be removed without scratching, marring, or otherwise damaging one of the aperture clip 62, main body 52a, or roof edge portion 40.

Further, mastic material 58a may provide a seal about at least a portion of a perimeter of aperture 29. Although mastic material 58a is generally shown in section in FIG. 3C, the mastic material may extend along a portion of or an entire length of the main body 52a. For example, as best seen in the sectional view of mastic material 58a in FIG. 3C, the section of mastic material 58a illustrates the mastic material 58a as being generally disposed about an entire perimeter of aperture 29, such that it provides a seal between extension platform 64a and roof edge portion 40 of the vehicle ditch 32, and also may bond a substantial portion of the main body 52a directly to the ditch 32. Accordingly, mastic material 58a may inhibit or prevent entirely the intrusion of any water or other contaminants that intrude into ditch 32. The ditch clip assembly 50a may thus provide two distinct features for preventing contaminant intrusion, e.g., water leakage, in the form of the sealing lips 90 of the ditch molding 22 and the mastic material 58a.

Aperture clip 62 may further include a circular, spherical, or otherwise rounded feature for selectively engaging main body 52a, as shown in FIGS. 3A-3C. For example, main body 52a may define a slot 70, e.g., a keyhole-shaped slot 57, that receives a circular stem portion 54 of aperture clip 62. Accordingly, aperture clip 62 may be selectively removed from main body 52a, and vice versa.

Further, ditch cover 22 may be secured to main body 52a with any feature that engages complementary features of main body 52. For example, as shown in FIGS. 3A-3C, cover clips 55 may be provided on opposing sides of main body 52a that engage corresponding cavities of ditch molding 22, thereby allowing for selective securement and removal of ditch cover 22. Thus, despite the generally permanent bonding of main body 52 to vehicle outer surface 28, ditch cover 22 may be selectively removed from main body 52, and main body 52 may be selectively removed from aperture clip 62. Selective removal of ditch cover 22 and/or main body 52 may be desirable for servicing ditch cover 22 and/or main body 52, such as where the ditch cover 22 or the main body 52 have become damaged. In particular, cover clips 55 may wear down over time or become damaged. Main body 52a may simply be replaced, thereby obviating any need to remove aperture clip 62 or any other portion of ditch clip assembly 50 that may be generally permanently bonded to the vehicle, such as with mastic material 58. Further, the selective removal of ditch cover 22 from main body 52 allows installation of different ditch covers 22 to vehicle 20, thereby allowing the use of multiple ditch covers having a different surface contour or color.

As best seen in FIGS. 3A and 3B, main body 52a includes various features for generally aligning the main body 52a within the ditch 32. For example, main body 52a includes four extension arms 80 that extend laterally from the main body 52a to abut surfaces of the ditch 32. The extension arms 80 thus collectively align main body 52a relative to the ditch 32. In other words, each of the extension arms 80 generally space the main body 52a away from a surface abutted by the extension arm 80 according to a length of each extension arm. The extension arms 80 may be relatively flexible. Although four extension arms 80 are shown, any number of extension arms may be employed that is convenient. To generally align the main body 52a laterally within the ditch 32, extension arms 80 may be provided on opposing sides of the main body 52a. For example, as shown in FIGS. 3A and 3B, extension arms 80a and 80b are disposed generally on opposite sides of the main body 52a, and define a span slightly greater than a width of the ditch 32. Accordingly, as the main body 52a is secured to the vehicle, e.g., by inserting aperture clip 62 into aperture 29, extension arms 80a and 80b each come into contact with their associated sides of the ditch 32, thereby maintaining a desired position of main body 52a laterally within the ditch 32. The extension arms 80 may abut any surface of the vehicle or ditch 32 that is convenient. For example, extension arms 80 may abut one of the vertically extending surfaces of the ditch 32, e.g., roof vertical portion 42 or side vertical portion 48 of ditch 32.

Main body 52a may also include features for spacing the main body 52a away from the ditch 32 and/or maintaining the main body 52a in tension above surfaces of the ditch, e.g., roof edge portion 40. For example, main body 52a is shown having four tension arms 82, with two tension arms 82 disposed adjacent each end of the main body 52a. The tension arms 82 are relatively flexible, and generally abut or engage a lower surface of the ditch 32, e.g., roof edge portion 40, when the main body 52a is installed to the vehicle. Accordingly, a tensioning force may be applied by each tension arm 82 against the roof edge portion 40, thereby tending to urge the main body 52a upwards such that the aperture clip 62 is drawn against the aperture. In other words, the tangs 63 of the aperture clip are urged against an edge of the aperture 29. Accordingly, the flexible tension arms 82 minimize any tendency of the main body 52a to squeak, rattle, or otherwise be displaced from an intended position after the aperture clip 62 is engaged with the vehicle.

Turning now to FIG. 4, another illustrative example of a ditch clip assembly 50b is shown. Ditch clip assembly 50b generally includes a main body 52b having an integrally formed aperture clip 62, a platform 64b for receiving mastic material 58b, and integrally formed cover clips 55 for selectively securing ditch cover 22. Accordingly, main body 52b may conveniently be generally formed in one piece. For example, main body 52b may be integrally formed in any known thermoplastic forming process, e.g., injection molding, extrusion, or the like. Ditch clip assembly 50b may be assembled to vehicle outer surface 28 in any manner that is convenient. For example, in contrast to ditch clip assembly 50a described above, mastic material 58b is shown generally integrally formed about platform 64b. Main body 52b may then be secured to vehicle outer surface 28 with aperture clip 62, thereby generally retaining main body 52b and mastic material 58b to vehicle outer surface 28 in a non-permanent manner. Mastic material 58b may then be generally heated, such as during a vehicle assembly process, thereby causing mastic material 58b to become generally soft, flowable, or tacky, thereby bonding main body 52b to vehicle outer surface 28 in a generally permanent manner. Accordingly, depending on the desired application, main body 52 and/or aperture clip 62 may be permanently or non-permanently bonded to the vehicle, depending on whether aperture clip 62 is non-removable from ditch clip assembly 50, as shown in FIG. 4, or is selectively removable from ditch clip assembly 50, as shown in FIGS. 3A-3C, respectively. Ditch cover 22 may be selectively secured to cover clips 55 of main body 52b, such as during final assembly of vehicle 20.

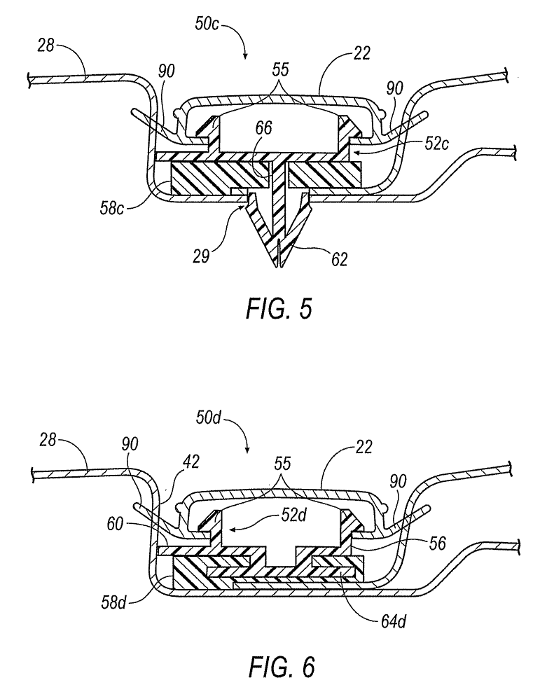

Turning now to FIG. 5, another exemplary illustration of a ditch clip assembly 50c is provided. Ditch clip assembly 50c generally includes a main body 52c having an integrally formed aperture clip 62 and integrally formed cover clips 55 for receiving ditch cover 22. Mastic material 58c is separately formed from main body 52c, such as in an extrusion, injection molding or other thermoplastic forming process. Mastic material 58c may be provided with apertures 66 for assembling to main body 52c and/or aperture clip 62. For example, as shown in FIG. 5, mastic material 58c may be formed with one or more apertures 66 that generally receive aperture clip 62 of main body 52c. Accordingly, mastic material 58c need not be integrally formed with main body 52c as described above in other examples, such that mastic material 58c may be initially assembled to main body 52c. The mastic material 58c and main body 52c may then be assembled together to vehicle outer surface 28 in a non-permanent manner, such as by inserting aperture clip 62 into aperture 29 of vehicle outer surface 28. At this point, the mastic material 58c and main body 52c may be removed from the vehicle, such as where the aperture clip 62 becomes damaged during insertion of the aperture clip 62 into aperture 29. Mastic material 58c may subsequently be subjected to a heating process to an activation temperature associated with the mastic material 58c, whereby mastic material 58c becomes generally soft, flowable, or tacky, thereby generally bonding or securing main body 52c to vehicle outer surface 28 in a permanent or otherwise non-removable manner. Ditch cover 22 may then be secured to main body 52d, such as by cover clips 55.

Turning now to FIG. 6, another exemplary illustration of a ditch clip assembly 50d is shown. Ditch clip assembly 50d generally includes a main body 52d, a mastic material 58d, and a ditch cover 22. Main body 52d does not include a fastener, e.g., aperture clip 62 described above, for engaging vehicle outer surface 28. Main body 52d instead is secured to vehicle outer surface 28 with mastic material 58d. Mastic material 58d may be formed with or assembled to main body 52d in any way described herein or otherwise known. For example, as described above, mastic material 58d may be insert-molded about a platform 64d of main body 52b. Platform 64d is spaced away from main body 52b. Main body 52b may further include integrally formed cover clips 55 for selectively securing ditch cover 22. Ditch clip assembly 50d may be generally assembled to vehicle outer surface 28 after mastic material 58d is formed with or otherwise assembled to main body 52d. Main body 52d may then be secured to vehicle outer surface 28 with mastic material 58d. For example, mastic material 58d may be generally heated, such as during a vehicle assembly process such that mastic material 58d becomes generally soft, tacky, or flowable, thereby generally securing main body 52d to vehicle outer surface 28. Main body 52d may further include an alignment feature, such as extension arm 60, which generally engages a roof vertical portion 42 of vehicle ditch 32 to maintain a proper location of ditch clip assembly 50d during placement of ditch clip assembly 50d and/or when the mastic material 58d is heated. Extension arm 60 may generally align main body 52b relative to ditch 32 and may especially be useful in the absence of any mechanical fasteners, e.g., aperture clip 62, that might otherwise generally align main body 52b with vehicle outer surface 28 and/or roof ditch 32.

Although main body 52d is shown in FIG. 6 as being formed generally integrally as a single piece, e.g., by extruding, main body 52d may be assembled in multiple parts to allow selective removal of at least the cover clips 55. For example, the cover clips 55 may include a circular stem that is received in a keyhole slot (not shown in FIG. 6) thereby allowing the selective removal of cover clips 55 from main body 52d. Further, the mastic material 58d is preferably disposed only around the platform 64d, and generally does not contact the selectively removable cover clips 55. Accordingly, after mastic material 58d is heated to the associated activation temperature such that mastic material 58d is permanently bonded to the vehicle surface 28, the cover clips 55 are not bonded to the mastic material 58d and therefore may be selectively removed to allow for replacement or service of the cover clips 55.

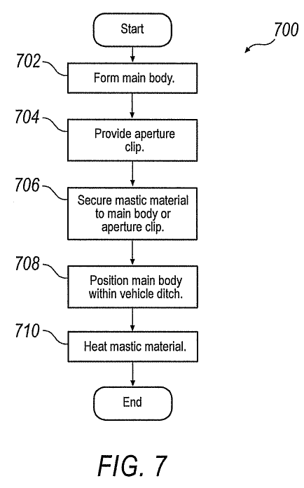

Turning now to FIG. 7, a process 700 for making a ditch clip assembly is illustrated. Process 700 may begin at step 702, where a main body is formed having at least one cover clip for selectively securing a ditch cover to said main body. For example, a main body 52 may be formed in any thermoplastic forming process, e.g., an extrusion process. An extrusion process may be especially convenient where main body 52 defines a generally similar or continuous cross-sectional profile along a length of the main body 52, such that the profile may be generally provided in a tool through which a thermoplastic material or the like is extruded. Process 700 may then proceed to step 704.

In step 704, an aperture clip is provided for securing the main body to an edge of an aperture defined by the vehicle ditch. For example, as described above, an aperture clip 62 may be formed separately from main body 52 and assembled to main body 52 in a manner that allows for selective removal of the aperture clip 62 from the main body 52. Accordingly, the aperture clip 62 may be selectively removable from the main body 52 after a mastic material 58 associated with the ditch clip assembly is heated such that it permanently bonds or secures the main body and/or aperture clip 62 to a vehicle surface. Alternatively, the aperture clip 62 may be integrally formed with the main body 52, such as in any thermoplastic forming process, e.g., extrusion. Process 700 may then proceed to step 706.

In step 706, a mastic material 58 is secured to the main body or aperture clip. The mastic material is configured to bond the ditch clip assembly to the ditch upon application of heat at an activation temperature, such that the mastic material seals along a perimeter of the aperture. In some examples, the mastic material 58 may seal a portion of a perimeter, substantially the entire perimeter, or even the entire perimeter, of the aperture. Accordingly, mastic material 58 may substantially inhibit, or even entirely prevent, intrusion of water or other contaminants from escaping through aperture 29, e.g., into an interior of a vehicle. The mastic material may be molded about or otherwise integrally formed with the main body, e.g., in an extrusion process, as described above. Alternatively, the mastic material 58 may be secured to the main body by inserting a feature of the main body, e.g., an aperture clip 62, into a hole or aperture 66 formed in the mastic material, as described above. Process 700 may then proceed to step 708.

In steps 708-710, a ditch clip assembly may be installed to a vehicle. For example, in step 708, the main body may be positioned within the vehicle ditch, such that the mastic material 58 is disposed between the main body 52 and the vehicle surface 28, as shown in FIG. 3C and described above. Proceeding to step 710, the mastic material is heated to an associated activation temperature, thereby bonding either or both of the main body 52 and the aperture clip 62 to the vehicle surface, e.g., roof edge portion 40 of ditch 32. Further, the activation of mastic material 58 and subsequent flowable nature of the mastic material 58 may result in sealing a portion, substantially all of, or an entire length of, a perimeter of the aperture 29. In other words, the mastic material 58 may generally become flowable to form a bond between main body 52 and the vehicle surface, e.g., roof edge portion 40, thereby sealing a portion or even the entire length of a perimeter of the aperture. The mastic material 58 may subsequently be cooled to room temperature, or any other general operating temperatures associated with vehicle use, such that the mastic material 58 become hardened and provides a seal.

Accordingly, the examples of a ditch clip assembly 50 and process 700 described herein provide for a variety of configurations that may be provided with features suited to the particular vehicle application for which the ditch clip assembly is intended. Where it is desired to ensure easy removal of the main body 52, an aperture clip 62 may be selectively removable from the main body 52 and an associated mastic material may engage the aperture clip only, such that the aperture clip is permanently installed to a vehicle once the mastic material is heated to the associated activation temperature. Alternatively, where ease of manufacturing and assembly is more important, the main body 52 may be generally entirely formed integrally as a single part, e.g., including cover clips 55 for selectively securing a ditch cover 22 and/or an aperture clip 62 configured to secure the ditch clip assembly 50 to the vehicle.

Reference in the specification to “one example,” “an example,” “one embodiment,” or “an embodiment” means that a particular feature, structure, or characteristic described in connection with the example is included in at least one example. The phrase “in one example” in various places in the specification does not necessarily refer to the same example each time it appears.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A ditch clip assembly for securing a ditch cover to a vehicle ditch, comprising:
a main body having at least one cover clip for selectively securing the ditch cover to said main body;
an aperture clip secured to said main body, said aperture clip configured to secure said main body to an edge of an aperture defined by the vehicle ditch; and
a mastic material secured to at least one of said main body and said aperture clip, said mastic material configured to bond the ditch clip assembly to the ditch upon application of heat at an activation temperature, wherein the mastic material seals along a perimeter of the aperture.

2. The ditch clip assembly of claim 1, wherein said aperture clip is selectively removable from said main body, thereby allowing selective removal of said main body from the vehicle after the application of said heat at said activation temperature.

3. The ditch clip assembly of claim 2, wherein said main body defines a slot for selectively securing said aperture clip to said main body.

4. The ditch clip assembly of claim 3, wherein said aperture clip includes a stem portion selectively securable to said slot of said main body.

5. The ditch clip assembly of claim 1, wherein said main body includes at least one extension arm configured to abut a surface of the vehicle ditch, thereby aligning said main body relative to the vehicle ditch.

6. The ditch clip assembly of claim 5, wherein said at least one extension arm includes two opposing extension arms disposed on opposite sides of said main body.

7. The ditch clip assembly of claim 6, wherein said two opposing extension arms are each configured to abut a vertically extending surface of the vehicle ditch, the vertically extending surface extending away from a bottom surface of the ditch.

8. The ditch clip assembly of claim 1, wherein said main body includes at least one tension arm configured to abut a bottom surface of the ditch, thereby tensioning said aperture clip into engagement with the edge of the aperture.

9. The ditch clip assembly of claim 8, wherein said at least one tension arms includes two tension arms disposed adjacent opposing ends of said main body.

10. The ditch clip assembly of claim 1, further comprising the ditch cover, said ditch cover being selectively removable from said main body.

11. The ditch clip assembly of claim 10, wherein said ditch cover includes sealing lips disposed on either side of said main body, said sealing lips configured to abut opposing sides of the ditch.

12. The ditch clip assembly of claim 1, wherein said main body includes an extension plate, said mastic material being formed about said extension plate.

13. The ditch clip assembly of claim 1, wherein said main body includes an extension plate, said mastic material being disposed on a bottom surface of said extension plate.

14. A ditch clip assembly for securing a ditch cover to a vehicle ditch, comprising:
a main body having at least one cover clip for selectively securing the ditch cover to said main body, said cover clip being selectively removable from said main body; and
a mastic material secured to said main body, said mastic material configured to bond at least a portion of said main body to the ditch upon application of heat at an activation temperature;
wherein said cover clip is selectively removable from said main body after said application of heat at said activation temperature.

15. The ditch clip assembly of claim 14, wherein said main body includes an extension arm configured to abut a surface of the vehicle ditch, thereby aligning said main body relative to the vehicle ditch.

16. A method of assembling a ditch clip assembly for securing a ditch cover to a vehicle ditch, comprising:
forming a main body having at least one cover clip for selectively securing a ditch cover to said main body;
providing an aperture clip for securing said main body to an edge of an aperture defined by the vehicle ditch; and
securing a mastic material to at least one of said main body and said aperture clip, said mastic material configured to bond the ditch clip assembly to the ditch upon application of heat at an activation temperature, wherein the mastic material seals along a perimeter of the aperture.

17. The method of claim 16, further comprising selectively removing said aperture clip from said main body, thereby allowing selective removal of said main body from the vehicle after the application of said heat at said activation temperature.

18. The method of claim 16, further comprising:
positioning said main body in the vehicle ditch, said mastic material disposed between said main body and the vehicle surface; and
heating said mastic material to said activation temperature, thereby bonding at least one of said main body and said aperture clip to the vehicle surface.

19. The method of claim 18, further comprising sealing along the perimeter of the aperture.

20. The method of claim 19, further comprising sealing along an entire length of the perimeter of the aperture.

21. The method of claim 16, wherein securing said mastic material to said main body includes molding said mastic material to said main body.

22. The method of claim 16, wherein securing said mastic material to said elongated main body includes inserting said aperture clip into a hole formed in said mastic material.
